(19) United States
(12) Patent Application Publication
(10) Pub. No.: US 2025/0385592 A1
(43) Pub. Date: Dec. 18, 2025

(54) SLOPE-COMPENSATION CLAMP CIRCUIT FOR SWITCHING CONVERTER SYSTEM

(71) Applicant: TEXAS INSTRUMENTS INCORPORATED, DALLAS, TX (US)

(72) Inventors: XINYU YIN, Beijing (CN); LIANG ZHANG, Beijing (CN); YUTAO WANG, RIZHAO (CN)

(21) Appl. No.: 18/746,755

(22) Filed: Jun. 18, 2024

(51) Int. Cl. H02M 1/00

(52) U.S. Cl. CPC H02M 1/0029; H02M 1/0009; H02M 1/0025

(57) ABSTRACT

One example method includes a circuit. The circuit includes a switching converter including at least one switch activated in response to a switching signal to provide an inductor current through an inductor to generate an output voltage across a load. The circuit also includes a switching control system. The switching control system includes a switch controller configured to generate the switching signal in response to an activation signal and a peak current mode controller configured to generate the activation signal in response to the inductor current being approximately equal to a slope-compensation current. The slope-compensation current includes a sum of a slope current and a compensation current generated via a compensation voltage. The peak current mode controller includes a slope-compensation clamp circuit configured to clamp the compensation voltage to a minimum amplitude that is based on the slope current.

### TECHNICAL FIELD

This description relates to electronic circuits, and more specifically to a slope-compensation clamp circuit for a switching converter system.

### BACKGROUND

Power converters are a family of electrical circuits which convert electrical energy from one level of voltage/current/frequency to another using semiconductor-based electronic switches. A characteristic of these types of circuits is that the switches are operated only in one of two states either fully ON or fully OFF—unlike other types of electrical circuits where the control elements are operated in a (near) linear active region. One type of power converter is a buck power converter that converts a direct current (DC) voltage from one amplitude to a lesser amplitude, such as based on pulse-width modulation (PWM) mode of at least one switch at a duty-cycle to provide current through an inductor to regulate the output voltage.

One type of buck converter is a peak current mode buck converter, in which the inductor current is compared with a threshold current amplitude to control activation of the switch(es). When the switching duty-cycle of the peak current mode buck converter is greater than approximately 50%, sub-harmonic oscillations can occur, which can result in undesirable performance issues of the buck converter. To remedy the sub-harmonic oscillations, peak current mode buck converters can implement slope-compensation control. Slope-compensation control implements a DC offset into the control loop of the peak current mode buck converter. However, slope-compensation control can also exhibit poor performance in response to load changes, such as transitioning between a pulse frequency modulation (PFM) mode at light load conditions to the PWM at higher load conditions.

### SUMMARY

One example method includes a circuit. The circuit includes a switching converter including at least one switch activated in response to a switching signal to provide an inductor current through an inductor to generate an output voltage across a load. The circuit also includes a switching control system. The switching control system includes a switch controller configured to generate the switching signal in response to an activation signal and a peak current mode controller configured to generate the activation signal in response to the inductor current being approximately equal to a slope-compensation current. The slope-compensation current includes a sum of a slope current and a compensation current generated via a compensation voltage. The peak current mode controller includes a slope-compensation clamp circuit configured to clamp the compensation voltage to a minimum amplitude that is based on the slope current.

Another example includes a circuit. The circuit includes a comparator configured to generate an activation signal in response to an inductor current of a switching converter being equal to a slope-compensation current. The slope-compensation current includes a sum of a slope current and a compensation current generated via a compensation voltage. The circuit also includes a feedback error amplifier configured to generate the compensation voltage based on an amplitude of a feedback voltage associated with an output voltage of the switching converter relative to a predefined reference voltage. The circuit also includes a slope generator configured to generate the slope current. The circuit further includes a slope-compensation clamp circuit configured to clamp the compensation voltage to a minimum amplitude based on the slope current.

Another example includes a circuit. The circuit includes a current source having an input and an output. The input of the current source can be adapted to receive a slope current of a peak current mode controller of a switching converter system. The circuit also includes a resistor having a first terminal and a second terminal. The first terminal of the resistor can be coupled to the output of the current source and the second terminal of the resistor being coupled to a low-voltage rail. The circuit also includes a switch comprising a control input, a switch input, and a switch output. The control input can be adapted to receive a switching signal of the switching converter system. The switch input can be coupled to the output of the current source. The circuit also includes a sampling capacitor having a first terminal and a second terminal. The first terminal of the sampling capacitor being coupled to the switch output and the second terminal of the sampling capacitor being coupled to the low-voltage rail. The circuit also includes a slope-compensation error amplifier having a first input, a second input, and an output. The first input of the slope-compensation error amplifier can be coupled to the switch output, and the second input of the slope-compensation error amplifier can be coupled to a compensation terminal that is adapted to receive a compensation voltage for slope-compensation control of the switching converter system. The circuit further includes a regulation transistor device having a first input, a second input, and an output. The first input of the regulation transistor device can be coupled to the output of the slope-compensation error amplifier, the second input of the regulation transistor device can be adapted to receive an input voltage, and the output of the regulation transistor device can be coupled to the compensation terminal.

### BRIEF DESCRIPTION OF THE DRAWINGS

FIG. 1 is an example block diagram of a switching converter system.

FIG. 2 is an example of a peak current mode controller.

FIGS. 3A, 3B, 3C, and 3D are example timing diagrams.

FIG. 4 is an example of a slope-compensation clamp circuit.

FIG. 5 is another example timing diagram.

FIG. 6 is another example timing diagram.

### DETAILED DESCRIPTION

This description relates to electronic circuits, and more specifically to a slope-compensation clamp circuit for a switching converter system. As described herein, the slope-compensation clamp circuit is configured to set a minimum amplitude for a compensation voltage to provide for a much more rapid recovery of an undershoot or overshoot of the output voltage of the switching converter system in response to a change in load conditions.

A switching converter system includes a switching control system and a switching converter. As an example, the switching converter system can operate as a peak current mode buck converter, such that the switching control system includes a peak current mode controller and a switch controller. The peak current mode controller can operate using slope-compensation to control the activation of at least one switch of the buck converter (e.g., a high-side switch) based on an amplitude of a current through an inductor of the buck converter relative to a slope compensated current threshold. As described herein, the term “activate” with respect to a transistor device corresponds to providing sufficient bias to the input terminal of the transistor device for the transistor device to act as a closed switch, thereby providing current or signal flow through the transistor device. Similarly, the term “deactivate” with respect to a transistor device corresponds to removing bias from the input terminal of the transistor device for the transistor device to act as an open switch, thereby ceasing current or signal flow through the transistor device.

Slope-compensation can implement a slope-compensation current that is a combination of a slope current and a compensation current. The slope current can have a varying amplitude fixed ramp having a slope that is approximately equal to a down-slope of the inductor current. The compensation current can provide a direct current (DC) offset to the slope current based on a compensation voltage that is generated based on a feedback voltage associated with the output voltage of the buck converter. The slope current can be subtracted from the compensation current to provide the slope-compensation current having a negative ramp in each switching period of the buck converter. The slope-compensation current can thus have a sufficient amplitude to provide a current threshold for operation of the buck converter in pulse-width modulation (PWM) mode. Therefore, at a duty-cycle of greater than approximately 50%, the slope-compensation mitigates sub-harmonic oscillation of the inductor current.

As an example, the buck converter system can operate in a pulse frequency modulation (PFM) mode during a light load condition, and can switch to the PWM mode during a heavy load condition. As described herein, the term “light load” refers to a low resistance/impedance of the load of the switching converter system, and the term “heavy load” refers to a high resistance/impedance of the load of the switching converter system. In the PFM mode, slope-compensation is not implemented for control of the peak current loop of the buck converter. In response to a change in the load, the output voltage changes. The peak current mode controller can include a feedback error amplifier that is configured to sample the compensation voltage in response to a change in the feedback voltage amplitude that is proportional to a change in the output voltage amplitude. For example, during the light load condition, the compensation voltage can have a low (e.g., approximately zero) amplitude. In response to a change from a light load condition to a heavy load condition, the amplitude of the output voltage decreases in an undershoot, resulting in a corresponding decrease in the amplitude of the feedback voltage relative to a predefined reference voltage. As a result, the feedback error amplifier increases the compensation voltage that is sampled onto a capacitor. The opposite is true in a change from a heavy load condition to a light load condition, that the output voltage increases in an overshoot, resulting in a corresponding increase in the amplitude of the feedback voltage relative to the predefined reference voltage. As a result, the feedback error amplifier decreases the compensation voltage that is sampled onto a capacitor.

The undershoot or the overshoot in the output voltage resulting from the change in load conditions can, over time, be corrected based on the change in the inductor current at each switching cycle. In the example of a change from a light load to a heavy load condition, the output voltage decreases rapidly from the nominal amplitude in an undershoot, then more slowly increases back to the nominal amplitude as the inductor current amplitude increases in each switching cycle until the inductor current amplitude through the heavier load is sufficient to again provide the nominal amplitude of the output voltage at a steady state (e.g., in PWM mode). Similarly, in the example of a change from a heavy load to a light load condition, the output voltage increases rapidly from the nominal amplitude in an overshoot, then more slowly decreases back to the nominal amplitude as the inductor current amplitude decreases in each switching cycle until the inductor current amplitude through the lighter load is sufficient to again provide the nominal amplitude of the output voltage at a steady state (e.g., in PFM mode).

As described above, the slope current is subtracted from the compensation current to generate the slope-compensation current. As also described above, at light load conditions, the compensation voltage from which the compensation current is generated can be very low (e.g., approximately zero). Therefore, in the light load condition, the slope-compensation current can be zero, and can remain zero even as the compensation voltage begins to increase. For example, the sum of the positive compensation current and the negative slope current can still result in a negative or zero amplitude slope-compensation current even at low non-zero amplitudes of the compensation voltage (e.g., less than a threshold defined by the switching duty-cycle and the slope of the slope current). Thus, in response to a change in load conditions from a light load to a heavy load, a conventional buck converter may not be able to begin switching in the PWM mode immediately after the change in load conditions. The result is that the undershoot in the amplitude of the output voltage can be long enough in duration to provide deleterious effects, such as on one or more circuits to which the buck converter provides power.

As described herein, the peak current mode controller of the buck converter system includes a slope-compensation clamp circuit to shorten the duration of time of an overshoot or undershoot of the output voltage of the buck converter system in response to a change in load conditions. The slope-compensation clamp circuit is configured to set a minimum amplitude of the compensation voltage, to a clamped amplitude, that is based on the slope current. The clamped amplitude can, for example, be greater than a minimum threshold at which the slope-compensation current is zero at the PWM duty-cycle.

For example, the slope-compensation clamp circuit can be configured to sample a slope voltage that is generated via the slope current to set the compensation voltage approximately equal to the slope voltage during operation of the buck converter system in the PFM mode. Therefore, in response to a change from the light load condition to a heavy load condition, the buck converter system can begin immediately switching in the PWM mode to increase the inductor current, as opposed to waiting until the slope-compensation current is greater than zero as the compensation voltage increases in response to a change in the output voltage. Similarly, in response to a change from the heavy load condition to a light load condition, the compensation voltage in the buck converter system can decrease to the clamped minimum amplitude faster than to zero volts as provided in a conventional buck converter system. Therefore, the buck converter system described herein can switch to a power saving mode (PSM) sooner than the conventional peak current mode buck converter to discharge the current in the inductor of the buck converter more rapidly than a conventional peak current mode buck converter. Accordingly, the buck converter system can return to the nominal amplitude of the output voltage more rapidly than a conventional buck converter system in response to an overshoot or undershoot of the output voltage.

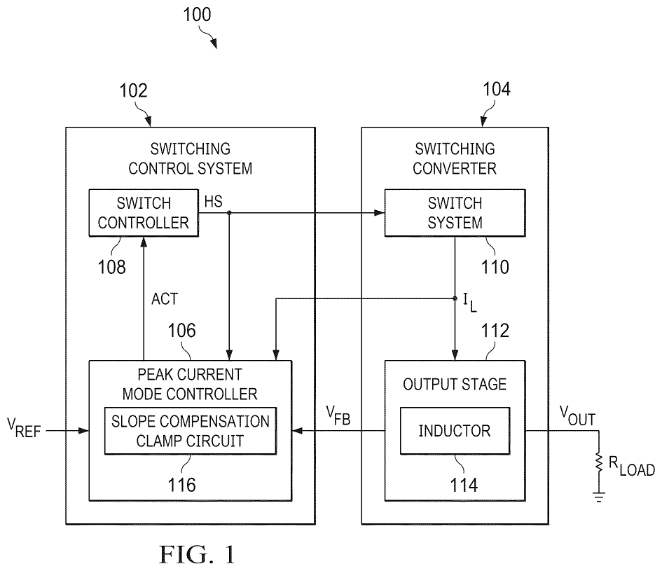

FIG. 1 is an example block diagram of a switching converter system 100. The switching converter system 100 can be implemented in any of a variety of applications that require DC power, such as in a wireless electronic device. As an example, the switching converter system 100 can be configured as a peak current mode buck converter system. As described herein, the switching converter system 100 can implement slope-compensation in a manner that provides for a much more rapid recovery of an undershoot or overshoot of the output voltage, demonstrated in the example of FIG. 1 as a voltage V_{OUT}, of the switching converter system 100 in response to a change in load, demonstrated in the example of FIG. 1 as a resistor R_{LOAD}.

The switching converter system 100 includes a switching control system 102 and a buck converter 104. In the example of FIG. 1, the switching control system 102 includes a peak current mode controller 106 and a switch controller 108. The buck converter 104 includes a switch system 110 that includes at least one switch (e.g., transistor device) and an output stage 112 that includes an inductor 114. As an example, the switching converter system 100 can operate as a peak current mode buck converter, such that the peak current mode controller 106 can operate using slope-compensation. In the example of FIG. 1, the peak current mode controller 106 is configured to provide an activation signal ACT to the switch controller 108 to control the activation of at least one switch (e.g., a high-side switch) of the switch system 110 via a switching signal HS. The activation signal ACT can be generated based on an amplitude of a current I_{L} through the inductor 114 of the buck converter 104 relative to a slope compensated current threshold. The current I_{L} through the inductor 114 is provided through the load R_{LOAD} to generate the output voltage V_{OUT}, as well as a feedback voltage V_{FB} that is provided from the output stage 112 and is proportional to the output voltage V_{OUT}.

As an example, the switching converter system 100 can operate in a pulse frequency modulation (PFM) mode during a light load condition (e.g., low resistance value of the load R_{LOAD}), and can switch to the PWM mode during a heavy load condition associated with the load R_{LOAD} (e.g., high resistance value of the load R_{LOAD}). In response to a change in the load R_{LOAD}, the output voltage V_{OUT} changes. As an example, the peak current mode controller 106 can include a feedback error amplifier that is configured to sample the compensation voltage in response to a change in an amplitude of the feedback voltage V_{FB} resulting from a change in the amplitude of the output voltage V_{OUT}.

For example, during the light load condition, the compensation voltage can have a low (e.g., approximately zero) amplitude. In response to a change from a light load condition to a heavy load condition, the amplitude of the output voltage decreases in an undershoot, resulting in a corresponding decrease in the amplitude of the feedback voltage relative to a predefined reference voltage. As a result, the feedback error amplifier increases the compensation voltage that is sampled onto a capacitor. The opposite is true in a change from a heavy load condition to a light load condition, that the output voltage increases in an overshoot, resulting in a corresponding increase in the amplitude of the feedback voltage relative to the predefined reference voltage. As a result, the feedback error amplifier decreases the compensation voltage that is sampled onto a capacitor.

In the example of FIG. 1, the peak current mode controller 106 includes a slope-compensation clamp circuit 116 that is configured to clamp the compensation voltage to a minimum amplitude based on the slope current. In the example of FIG. 1, the switching signal HS is also provided to the peak current mode controller 106, such as to provide a sampling trigger for the slope-compensation clamp circuit 116 to sample a slope voltage associated with the slope current to control a current source to clamp the amplitude of the compensation voltage approximately equal to the slope voltage. As described in greater detail herein, the clamped amplitude of the compensation voltage can shorten the duration of time of an overshoot or undershoot of the output voltage V_{OUT} of the switching converter system 100 in response to a change in load conditions.

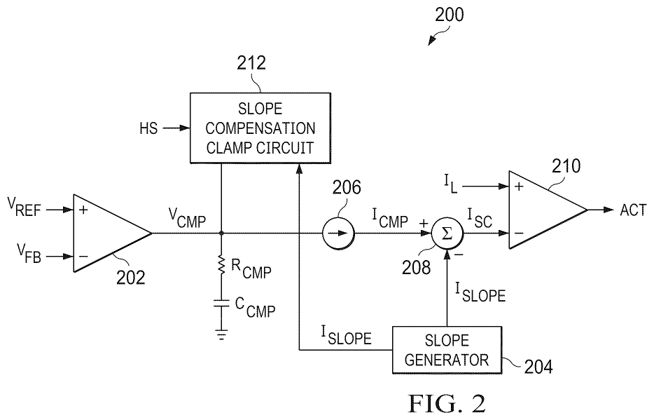

FIG. 2 is an example of a peak current mode controller 200. The peak current mode controller 200 can correspond to the peak current mode controller 106. Therefore, reference is to be made to the example of FIG. 1 in the following description of the example of FIG. 2.

The peak current mode controller 200 includes a feedback error amplifier 202 that is configured to generate the compensation voltage V_{CMP} based on a difference between the feedback voltage V_{FB} and a predefined reference voltage V_{REF}. As described above, the feedback voltage V_{FB}, provided by the output stage 112, is proportional to the output voltage V_{OUT}. The predefined reference voltage V_{REF} can have an amplitude that is approximately equal to the feedback voltage V_{FB} at a steady-state operation of the switching converter system 100 at which the switching converter system 100 generates the output voltage V_{OUT} at a nominal amplitude in either the PWM mode or the PFM mode. Therefore, the amplitude of the compensation voltage V_{CMP} can change in response to changes in the feedback voltage V_{FB} relative to the predefined reference voltage V_{REF}.

The compensation voltage V_{CMP} can be provided from the output of the feedback error amplifier 202 and stored as charge on a capacitor C_{CMP} via a resistor R_{CMP}, thereby maintaining the amplitude of the compensation voltage V_{CMP} in steady-state conditions. Therefore, a decrease in the feedback voltage V_{FB} resulting from a change in load conditions from light load to heavy load provides an increase in the amplitude of the compensation voltage V_{CMP} which is maintained as the feedback voltage V_{FB} increases back to approximately the amplitude of the reference voltage V_{REF} after an undershoot of the output voltage V_{OUT} is corrected. Similarly, an increase in the feedback voltage V_{FB} resulting from a change in load conditions from heavy load to light load provides a decrease in the amplitude of the compensation voltage V_{CMP}, from the higher amplitude stored on the capacitor C_{CMP} back to a minimum value which is maintained as the feedback voltage V_{FB} decreases back to approximately the amplitude of the reference voltage V_{REF} after an overshoot of the output voltage V_{OUT} is corrected.

The peak current mode controller 200 also includes a slope generator 204, a current source 206, and a summation component 208. The slope generator 204 is configured to generate the slope current I_{SLOPE}. The slope current I_{SLOPE} can be implemented in slope-compensation techniques for buck converters, such as to mitigate sub-harmonic oscillation of the inductor current I_{L} for operating the switching converter system 100 at a duty-cycle of greater than approximately 50% in the PWM mode. As described herein, the slope current I_{SLOPE} can have a varying amplitude fixed ramp having a period that is equal to the PWM mode switching period and having a slope that is approximately equal to a down-slope of the inductor current I_{L} (e.g., based on the inductance of the inductor 114). The current source 206 is configured to generate a compensation current I_{CMP} based on the compensation voltage V_{CMP}, and the summation component 208 is configured to combine the slope current I_{SLOPE} from the compensation current I_{CMP} to generate a slope-compensation current I_{SC}. Therefore, the slope-compensation current I_{SC} can be a negative ramp in each of the PWM switching periods having a direct current (DC) offset based on the compensation current I_{CMP}, and thus the compensation voltage V_{CMP}.

The peak current mode controller 200 also includes a comparator 210 configured to compare the amplitude of the inductor current I_{L} with the amplitude of the slope-compensation current I_{SC}. In response to the inductor current I_{L} being greater than the slope-compensation current I_{SC}, the comparator 210 generates the activation signal ACT. The activation signal ACT can thus be provided to the switch controller 108, which can operate as a buffer to generate the switching signal HS as an inversion of the activation signal ACT, to control activation of at least one switch in the switch system 110. The switching signal HS can, for example, correspond to a high-side switching signal that activates a high-side transistor device of a half-bridge or two transistor devices of a full-bridge to provide the inductor current I_{L} through the inductor 114, thereby providing the output voltage V_{OUT} through the load R_{LOAD}. Based on the DC offset provided by the compensation voltage V_{CMP}, the slope-compensation current I_{SC} can thus have a sufficient amplitude to provide a current threshold for nominal operation of the switching converter system 100 in PWM mode.

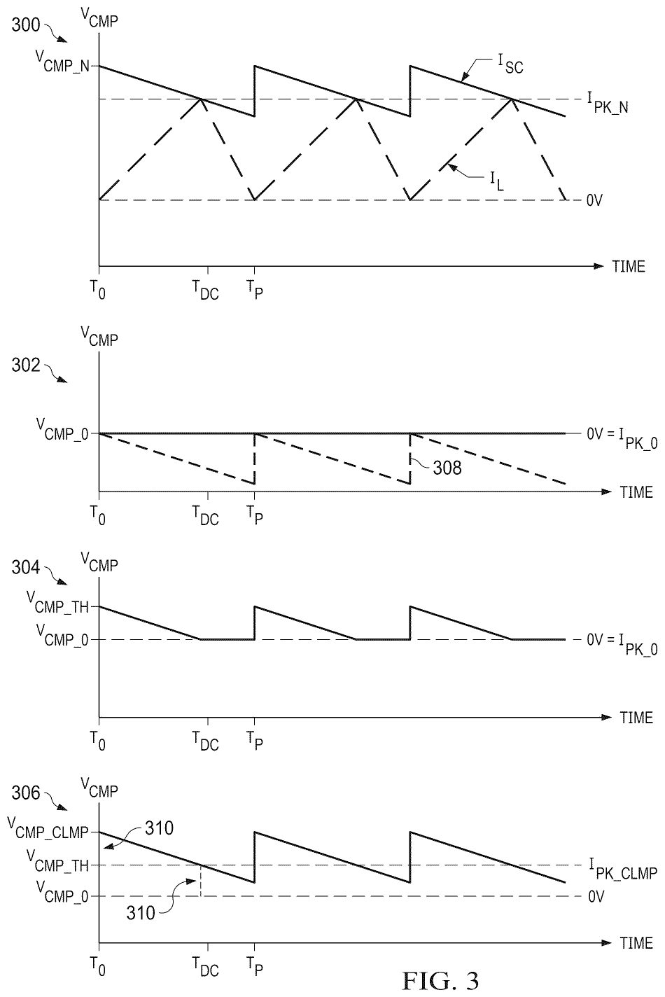

FIGS. 3A, 3B, 3C, and 3D are example timing diagrams. The timing diagrams are demonstrated as a first timing diagram 300 in the example of FIG. 3A, a second timing diagram 302 in the example of FIG. 3B, a third timing diagram 304 in the example of FIG. 3C, and a fourth timing diagram 306 in the example of FIG. 3D. The timing diagrams 300, 302, and 304 demonstrate different amplitudes of the slope-compensation current I_{SC} based on different respective amplitudes of the compensation voltage V_{CMP}.

The first timing diagram 300 demonstrates the slope-compensation current I_{SC} at a nominal amplitude of the switching converter system 100 in PWM mode. In the first timing diagram 300, the compensation voltage V_{CMP} is demonstrated as having a nominal amplitude V_{CMP_N}, and thus provides the DC offset that corresponds to steady-state operation of the switching converter system 100 in the PWM mode. Therefore, the first timing diagram 300 demonstrates a switching period of the switching converter system 100 in the PWM mode as beginning at a time T₀ and ending at a time T_{P}.

In each switching period of the PWM mode, the slope-compensation current I_{SC} decreases from a maximum amplitude that is approximately equal to the compensation current I_{CMP} (at which the slope current I_{SLOPE} is approximately equal to zero) at the time T₀ to a minimum amplitude (at which the slope current I_{SLOPE} has a maximum amplitude) at the time T_{P}. At the time T₀, the inductor current I_{L} is less than the slope-compensation current I_{SC}. Therefore, the activation signal ACT is provided to the switch controller 108 to provide the switching signal HS to activate the switch(es) to provide the current I_{L} through the inductor 114. Therefore, at the time T₀, the inductor current I_{L} begins increasing from zero to a nominal peak amplitude I_{PK_N} at a time T_{DC} corresponding to a duty-cycle of the switching period. The nominal peak amplitude I_{PK_N} thus corresponds to the amplitude of the inductor current I_{L} that is approximately equal to the amplitude of the slope-compensation current I_{SC} (e.g., the intersection of the increasing inductor current I_{L} with the decreasing slope-compensation current I_{SC}). Therefore, the activation signal ACT changes the switching signal HS to deactivate the switch(es) to cease the current I_{L} through the inductor 114. Accordingly, the inductor current I_{L} decreases from the nominal peak amplitude I_{PK_N} at the time T_{DC} back to zero at the time T_{P}. At the time T_{P}, the next period begins, such that the above described process starts over.

The second timing diagram 302 demonstrates the slope-compensation current I_{SC} at a significantly lower amplitude of a conventional peak current mode buck converter operating in PFM mode. In the second timing diagram 302, the compensation voltage V_{CMP} is demonstrated as having an amplitude V_{CMP_}0 corresponding to an amplitude of zero volts. Therefore, in the second timing diagram 302, the compensation voltage V_{CMP} provides no DC offset from which the slope current I_{SLOPE} is subtracted from. A theoretical negative slope current I_{SLOPE} is demonstrated as dotted lines at 308 at amplitudes less than zero. However, because the arrangement of the summation component 208 can prohibit a zero amplitude slope-compensation current I_{SC}, the subtraction of the slope current I_{SLOPE} from the zero amplitude compensation current I_{CMP} results in a slope-compensation current I_{SC} having a constant zero amplitude. Because the slope-compensation current I_{SC} has a constant zero amplitude in the example of the second timing diagram 302, the peak current amplitude is zero, demonstrated as I_{PK_}0, such that the inductor current I_{L} cannot increase after switching to the PWM mode at the duty-cycle time TDC or any other time during the switching period of T₀ through T_{P} until the slope-compensation current I_{SC} increases. Therefore, the inductor current I_{L} cannot increase in the example of the second timing diagram 302 until the compensation voltage V_{CMP} increases as a result of a load condition change from a light load to a heavy load.

The third timing diagram 304 demonstrates the slope-compensation current I_{SC} that is generated based on subtracting the slope current I_{SLOPE} from the compensation current I_{CMP} when the compensation voltage V_{CMP} has an amplitude V_{CMP_TH} corresponding to a minimum threshold amplitude. The amplitude V_{CMP_TH} is demonstrated in the example of the third timing diagram 304 as greater than zero, but less than the nominal amplitude V_{CMP_N}. The threshold amplitude V_{CMP_TH} can be such that the slope-compensation current I_{SC} has an amplitude that decreases to zero at the time T_{DC}. The slope-compensation current I_{SC} at the threshold amplitude V_{CMP_TH} is thus positive prior to the time T_{DC}, but is zero at the time T_{DC} and at times subsequent to the time T_{DC}. Thus, the peak current amplitude I_{PK} is zero at the time T_{DC}, and thus demonstrated again as I_{PK_}0. Therefore, the threshold amplitude V_{CMP_TH} corresponds to the amplitude at which any greater amplitude of the compensation voltage V_{CMP} can provide for an increase in the inductor current I_{L} at the switching duty-cycle T_{DC} in the PWM mode.

Therefore, the examples of FIGS. 3A, 3B, and 3C demonstrate different amplitudes of the compensation voltage V_{CMP} and how the different amplitudes affect the activation signal ACT, and thus the switching of the switch(es) of the switch system 110 to provide the inductor current I_{L} through the inductor 114. Particularly, the first timing diagram 300 demonstrates a nominal amplitude of the compensation voltage V_{CMP_N} for steady-state operation of the switching converter system 100 in the PWM mode. The second timing diagram 302 demonstrates a zero amplitude compensation voltage V_{CMP_}0, such as can occur in a light load condition, during which a conventional buck converter system can operate in the PFM mode. The third timing diagram 304 demonstrates the threshold amplitude V_{CMP_TH} corresponding to the minimum above which the inductor current I_{L} can increase in the PWM mode.

As described above, in response to a change in load conditions from a light load to a heavy load, the amplitude of the output voltage V_{OUT} decreases, resulting in a corresponding decrease in the amplitude of the feedback voltage V_{FB} relative to the predefined reference voltage V_{REF}. As a result, the feedback error amplifier 202 increases the compensation voltage V_{CMP} that is sampled onto the capacitor C_{CMP}. The increase in the compensation voltage V_{CMP} results in an increase in the slope-compensation current I_{SC}, and the conventional buck converter system can begin switching in the PWM mode to gradually increase the amplitude of the inductor current I_{L}.

Beginning at the load change from light load to heavy load, the conventional buck converter exhibits an undershoot of the output voltage V_{OUT} until the inductor current of the conventional buck converter can have a sufficient amplitude to regulate the output voltage V_{OUT} to the nominal amplitude, such as demonstrated in the first timing diagram 300 in the example of FIG. 3A. For a conventional buck converter system operating in the light load condition, the compensation voltage V_{CMP} can be approximately equal to zero, such as demonstrated in the second timing diagram 302. Therefore, in response to the load change from light load to heavy load, the compensation voltage V_{CMP} increases from an initial amplitude of zero, through the range of amplitudes less than the threshold amplitude V_{CMP_TH} to the threshold amplitude V_{CMP_TH}, and through the range of amplitudes greater than the threshold amplitude V_{CMP_TH} to the nominal amplitude V_{CMP_N}. However, as described above, the conventional buck converter does not control the switch(es) to increase the inductor current until the compensation voltage V_{CMP} is greater than the threshold amplitude V_{CMP_TH}. As a result, the conventional buck converter cannot immediately react to the change in the load conditions based on the inability of the conventional buck converter system to begin switching in the PWM mode immediately after the change in load conditions. As a result, the undershoot in the amplitude of the output voltage V_{OUT} can be undesirably long in duration, thereby providing potentially deleterious effects.

Referring back to the example of FIG. 2, the peak current mode controller 200 further includes a slope-compensation clamp circuit 212. The slope-compensation clamp circuit 212 is coupled to the output of the feedback error amplifier 202, and is configured to clamp the amplitude of the compensation voltage V_{CMP} to a minimum amplitude V_{CMP_CLMP} based on the slope current I_{SLOPE} and the switching signal HS. As an example, the minimum amplitude V_{CMP_CLMP} can be greater than the threshold amplitude V_{CMP_TH}, as demonstrated in the fourth timing diagram 306 in the example of FIG. 3D. As an example, the slope-compensation clamp circuit 212 can be configured to clamp the amplitude of the compensation voltage V_{CMP} to the minimum amplitude V_{CMP_CLMP} in a light load condition, such as during a steady-state PFM mode operation of the switching converter system 100.

In the fourth timing diagram 306, the clamped minimum amplitude V_{CMP_CLMP} results in a clamped peak current amplitude I_{PK_CLMP} that is greater than zero, demonstrated at 310 as having an amplitude V_{CMP_CLMP}−V_{CMP_TH}. As described above, in response to a change in load conditions from a light load to a heavy load, the amplitude of the output voltage V_{OUT} decreases, resulting in a corresponding decrease in the amplitude of the feedback voltage V_{FB} relative to the predefined reference voltage V_{REF}. As a result, the feedback error amplifier 202 increases the compensation voltage V_{CMP} that is sampled onto the capacitor C_{CMP}. Based on the compensation voltage V_{CMP} having the minimum amplitude V_{CMP_CLMP} at the time of the load change, the increase of the compensation voltage V_{CMP} begins from the clamped minimum amplitude V_{CMP_CLMP}, as opposed to an amplitude of zero.

Therefore, in response to the load change from the light load to the heavy load, the switching converter system 100 can begin to immediately activate the switch(es) of the switch system 110 to increase the inductor current I_{L}, as opposed to the conventional buck converter system that is delayed in switching until the compensation voltage V_{CMP} increases from zero to greater than the threshold amplitude V_{CMP_TH}. As a result, the duration of the undershoot of the output voltage V_{OUT} can be significantly mitigated based on the shorter duration of time for the switching converter system 100 to achieve steady-state switching of the switch(es) of the switch system 110 to provide sufficient amplitude of the inductor current I_{L} to provide the nominal amplitude of the output voltage V_{OUT}. Furthermore, the switching converter system 100 achieves the clamping of the compensation voltage V_{CMP} to the minimum amplitude V_{CMP_CLMP} without sensing the DC offset at each switching cycle and adjusting the DC offset to zero via a large RC constant low-pass filter in a sample-and-hold architecture, as is provided in other clamping architectures. Accordingly, the switching converter system 100 can be fabricated on a significantly smaller die area (e.g., by approximately 40%) than buck converter systems that implement other clamping architectures.

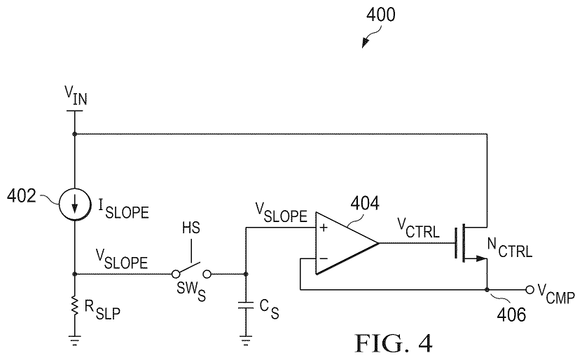

FIG. 4 is an example of a slope-compensation clamp circuit 400. The slope-compensation clamp circuit 400 can correspond to the slope-compensation clamp circuit 212 in the example of FIG. 2. Therefore, reference is to be made to the example of FIG. 2 in the following description of the example of FIG. 4.

The slope-compensation clamp circuit 400 includes a current source 402 that is configured to provide the slope current I_{SLOPE} to the slope-compensation clamp circuit 400 via an input voltage V_{IN}. As an example, the slope current I_{SLOPE} can be provided from a current mirror (not shown) that is associated with the slope generator 204, such that the input voltage V_{IN} can be common to the slope generator 204 and the slope-compensation clamp circuit 400. The slope current I_{SLOPE} is provided through a resistor R_{SLP} to generate a slope voltage V_{SLOPE}. The slope voltage V_{SLOPE} can thus correspond to a ramp voltage that is proportional to the ramp of the slope current I_{SLOPE}.

The slope-compensation clamp circuit 400 also includes a sampling switch SW_{S} and a slope-compensation error amplifier 404. The sampling switch SW_{S} is controlled by the switching signal HS, and is thus closed in response to the switching signal HS (e.g., assertion of the switching signal HS). Therefore, in response to assertion of the switching signal HS, such as corresponding to activation of a high-side switch of the switch system 110, the sampling switch SW_{S} closes to sample the voltage V_{SLOPE} onto a sampling capacitor C_{S}. Upon de-assertion of the switching signal HS, the slope voltage V_{SLOPE} is provided on the sampling capacitor C_{S} at a static amplitude, as described in greater detail below.

The sampling capacitor C_{S} is coupled to a first input of the slope-compensation error amplifier 404. In the example of FIG. 4, a second input of the slope-compensation error amplifier 404 is coupled to a compensation terminal 406 on which the compensation voltage V_{CMP} is provided. The compensation terminal 406 can correspond to the terminal at the output of the feedback error amplifier 202 in the example of FIG. 2. Therefore, the slope-compensation error amplifier 404 is configured to provide a control voltage V_{CTRL} that has an amplitude that is based on a difference between the slope voltage V_{SLOPE} and the compensation voltage V_{CMP}. In the example of FIG. 4, the control voltage V_{CTRL} is provided to a gate of a regulation transistor device N_{CTRL} that is coupled between the input voltage V_{IN} and the compensation terminal 406. The regulation transistor device N_{CTRL} is thus configured to operate in linear mode based on the amplitude of the control voltage V_{CTRL}, which is based on a difference in amplitude between the compensation voltage V_{CMP} and the slope voltage V_{SLOPE}. Therefore, the regulation transistor device N_{CTRL} is configured to regulate the amplitude of the compensation voltage V_{CMP} to be approximately equal to the slope voltage V_{SLOPE}. Accordingly, the slope-compensation error amplifier 404 is configured to set the amplitude of the compensation voltage V_{CMP} to be approximately equal to the slope voltage V_{SLOPE} corresponding to the clamped minimum amplitude V_{CMP_CLMP}.

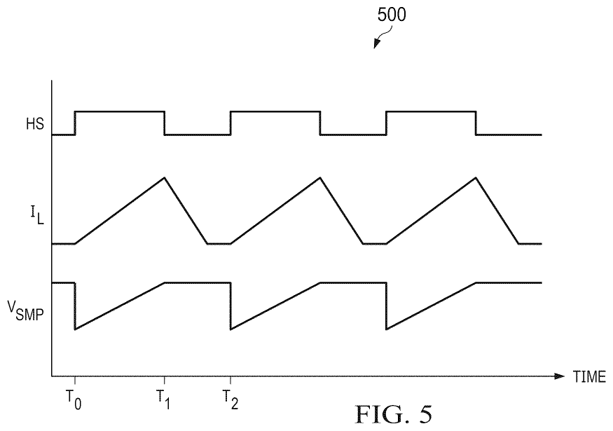

The operation of the slope-compensation clamp circuit 400 is demonstrated with reference to the example of FIG. 5. FIG. 5 is another example timing diagram 500. The timing diagram 500 includes the switching signal HS, the inductor current I_{L}, and the slope voltage V_{SLOPE} plotted as a function of time. As an example, the timing diagram 500 can correspond to operation of the switching converter system 100 during steady state operation in the PFM mode.

At a time T₀, the switching signal HS is asserted to a logic-1. As an example, the switching signal HS can correspond to a high-side switching signal. Therefore, in response to assertion of the switching signal HS, the high-side switch in the switch system 110 is asserted to provide the inductor current I_{L} through the inductor 114. In the example of FIG. 5, the inductor current I_{L} is demonstrated as beginning a PFM pulse at the time T₀, and thus begins to increase from an amplitude zero at the time T₀. In addition to activating the high-side switch of the switch system 110, the switching signal HS is provided to the sampling switch SW_{S} in the slope-compensation clamp circuit 400. Therefore, the sampling switch SW_{S} is closed at the time T₀ to provide the slope voltage V_{SLOPE} to the sampling capacitor C_{S}, thereby providing the slope voltage V_{SLOPE} onto the sampling capacitor C_{S}.

At a time T₁, the switching signal HS is de-asserted, thereby opening the sampling switch SW_{S}. In response to the opening of the sampling switch SW_{S}, the slope voltage V_{SLOPE} is provided on the sampling capacitor C_{S} at a static amplitude. At the time T₁, the amplitude of the slope voltage V_{SLOPE} that is sampled on the sampling capacitor C_{S} is provided at a static amplitude, despite the slope voltage V_{SLOPE} across the resistor R_{SLP} continuing to increase. Therefore, at the time T₁, the slope-compensation error amplifier 404 can compare the sampled slope voltage V_{SLOPE} with the compensation voltage V_{CMP}. In response to the compensation voltage V_{CMP} having a lesser amplitude than the sampled slope voltage V_{SLOPE}, the slope-compensation error amplifier 404 can provide the control voltage V_{CTRL} to the regulation transistor device N_{CTRL}. The regulation transistor device N_{CTRL} can thus provide current flow to the compensation terminal 406, thereby increasing the amplitude of the compensation voltage V_{CMP} to be approximately equal to the sampled slope voltage V_{SLOPE}. In this manner, the slope-compensation error amplifier 404 and regulation transistor device N_{CTRL} can consistently regulate the amplitude of the compensation voltage V_{CMP} to be clamped to a minimum amplitude V_{CMP_CLMP} that is approximately equal to the sampled slope voltage V_{SLOPE}.

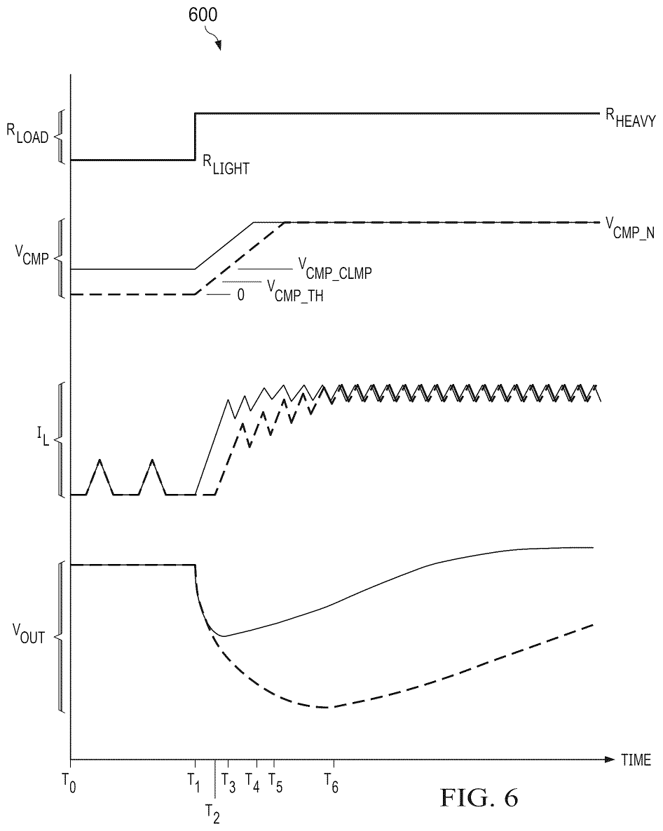

The operation of the switching converter system 100 is further described in the example of FIG. 6. FIG. 6 is another example timing diagram 600. The timing diagram 600 includes the load R_{LOAD}, the compensation voltage V_{CMP}, the inductor current I_{L}, and the output voltage V_{OUT} plotted as a function of time. The voltages and current demonstrated in the example of FIG. 6 are demonstrated by example and simplistically (e.g., with smooth transitions and/or constant values) for ease in explanation, but in practice may appear differently.

At a time T₀, the switching converter system 100 is demonstrated as operating in a steady-state PFM mode in a light load condition. The load R_{LOAD} is demonstrated as having a relatively lower resistance value R_{LIGHT}. The compensation voltage V_{CMP} is demonstrated at two minimum values. The dotted line compensation voltage V_{CMP} corresponds to the compensation voltage V_{CMP} for a conventional buck converter system. The dotted line compensation voltage V_{CMP} is thus demonstrated at the minimum amplitude of approximately zero volts at the time T₀, similar to as described in the example second timing diagram 302 above. The solid line compensation voltage V_{CMP} corresponds to the compensation voltage V_{CMP} generated by the peak current mode controller 200, and thus clamped to the minimum amplitude V_{CMP_CLMP} by the slope-compensation clamp circuit 400, as described in the examples of FIGS. 3D and 4 above. Furthermore, at the time T₀, the inductor current I_{L} is demonstrated as having a minimal amplitude (e.g., zero) with occasional PFM pulses being provided in the steady-state PFM mode. The output voltage V_{OUT} is provided at a constant nominal amplitude (e.g., 3 volts or 5 volts).

At a time T₁, the load R_{LOAD} changes condition from the light load R_{LIGHT} to a relatively heavy load R_{HEAVY}. In response to the load change at the time T₁, the output voltage V_{OUT} exhibits an undershoot in amplitude. The decrease in the amplitude of the output voltage V_{OUT} provides for a corresponding decrease to the feedback voltage V_{FB}. Therefore, the feedback error amplifier 202 increases the amplitude of the compensation voltage V_{CMP} based on the difference in amplitude between the feedback voltage V_{FB} and the reference voltage V_{REF}.

As described above, the compensation voltage V_{CMP} (solid line) is clamped to the minimum amplitude V_{CMP_CLMP} by the slope-compensation clamp circuit 400 at the time T₁. Therefore, the compensation voltage V_{CMP} increases immediately from the clamped minimum amplitude V_{CMP_CLMP} at the time T₁ to a nominal amplitude V_{CMP_N} at a time T₄. Based on the increase of the compensation voltage V_{CMP} (solid line), the switching converter system 100 can immediately activate the switch(es) of the switch system 110 via the activation signal ACT provided by comparator 210 at the time T₁ as a result of the minimum clamped amplitude of the compensation voltage V_{CMP} being greater than the threshold amplitude V_{CMP_TH} at the time T₁. Therefore, the inductor current I_{L} is demonstrated as increasing immediately at the time T₁ from approximately zero to a significantly higher PWM steady-state at a time shortly after the time T₄. As a result, the undershoot of the output voltage V_{OUT} decreases to a minimum amplitude V_{OUT_1} at a time T₃ before beginning to increase as the switching converter system 100 achieves steady-state switching of the switch(es) of the switch system 110 to provide sufficient amplitude of the inductor current I_{L} to return the amplitude of the output voltage V_{OUT} to the nominal amplitude.

As also described above, the conventional compensation voltage V_{CMP} (dotted line) is at a minimum amplitude of approximately zero at the time T₁. Similar to as described above, the conventional compensation voltage V_{CMP} begins to increase at the time T₁ in response to the undershoot of the output voltage V_{OUT}, achieving the nominal amplitude at a time T₅. However, as also described above, the conventional buck converter cannot control the switch(es) to increase the inductor current I_{L} until the conventional compensation voltage V_{CMP} is greater than the threshold amplitude V_{CMP_TH}. Therefore, as demonstrated in the example of FIG. 6, the conventional inductor current I_{L} (dotted line) does not begin to increase at the time T₁.

The conventional compensation voltage V_{CMP} increases greater than the threshold amplitude V_{CMP_TH} at a time T₂ subsequent to the time T₁. Thus, at the time T₂, the conventional inductor current I_{L} begins to increase based on the switching of the switch(es) of the conventional buck converter, achieving steady-state PWM switching at a time shortly after the time T₅. Therefore, the conventional buck converter is unable to react to the change in the load conditions at the time T₁, unlike the switching converter system 100 described herein. Therefore, the conventional output voltage V_{OUT} (dotted line) continues to decrease in an undershoot after the time T₃, thereby decreasing to a minimum amplitude V_{OUT_2} at a time T₆ before beginning to increase as the conventional buck converter system achieves steady-state switching. As a result, the example of FIG. 6 demonstrates that the switching converter system 100 is able to recover the undershoot of the output voltage V_{OUT} or much more rapidly than the conventional buck converter system.

As demonstrated in the example of FIG. 6, the switching converter system 100 can mitigate the undershoot in the amplitude of the output voltage V_{OUT} relative to the conventional buck converter based on clamping the compensation voltage V_{CMP} to the clamped minimum amplitude V_{CMP_}CLMP. While the example of FIG. 6 and the discussion above provides the example of a load change from the light load R_{LIGHT} to the heavy load R_{HEAVY}, the operation of the switching converter system 100 is similar in response to a load change from the heavy load R_{HEAVY} to the light load R_{LIGHT}, which results in an overshoot of the amplitude of the output voltage V_{OUT}. As an example, the decrease in the compensation voltage V_{CMP} from the nominal amplitude V_{CMP_N} to the clamped minimum amplitude V_{CMP_CLMP} can occur more rapidly than the decrease of the conventional compensation voltage from the nominal amplitude V_{CMP_N} to zero. As a result, the switching converter system 100 can switch to a power saving mode (PSM) more rapidly than a conventional buck converter system. In the PSM, the switching converter system 100 ceases switching of the switch(es) of the switch system 110 in response to the amplitude of the output voltage V_{OUT} being greater than a desired amplitude. As a result, based on the switching converter system 100 switching from the PWM mode to the PSM more rapidly than the conventional buck converter, the switching converter system 100 can provide for a shorter duration overshoot of the amplitude of the output voltage V_{OUT} relative to the conventional buck converter system. Accordingly, the switching converter system 100 can mitigate undesirably long duration undershoots and overshoots that can provide potentially deleterious effects.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

In this description, the term “couple” can cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function can be configured (e.g., programmed and/or hardwired) at a time of manufacturing by a manufacturer to perform the function and/or can be configurable (or reconfigurable) by a user after manufacturing to perform the function and/or other additional or alternative functions. The configuring can be through firmware and/or software programming of the device, through a construction and/or layout of hardware components and interconnections of the device, or a combination thereof. Furthermore, a circuit or device that is described herein as including certain components can instead be configured to couple to those components to form the described circuitry or device. For example, a structure described herein as including one or more semiconductor elements (such as transistor devices), one or more passive elements (such as resistors, capacitors, and/or inductors), and/or one or more sources (such as voltage and/or current sources) can instead include only the semiconductor elements within a single physical device (e.g., a semiconductor die and/or integrated circuit (IC) package) and can be configured to couple to at least some of the passive elements and/or the sources to form the described structure, either at a time of manufacture or after a time of manufacture, such as by an end-user and/or a third-party.

The phrase “based on” means “based at least in part on”. Therefore, if X is based on Y, X can be a function of Y and any number of other factors.

Modifications are possible in the described embodiments, and other embodiments are possible, within the scope of the claims.

What is claimed is:

1. A circuit comprising:
a switching converter comprising at least one switch activated in response to a switching signal to provide an inductor current through an inductor to generate an output voltage across a load; and
a switching control system comprising:
a switch controller configured to generate the switching signal in response to an activation signal; and
a peak current mode controller configured to generate the activation signal in response to the inductor current being approximately equal to a slope-compensation current, the slope-compensation current comprising a sum of a slope current and a compensation current generated via a compensation voltage, the peak current mode controller comprising a slope-compensation clamp circuit configured to clamp the compensation voltage to a minimum amplitude that is based on the slope current.

2. The circuit of claim 1, wherein the slope-compensation clamp circuit is configured to generate a slope voltage associated with the slope current, wherein the slope-compensation clamp circuit comprises a slope-compensation error amplifier configured to regulate the compensation voltage to be approximately equal to the slope voltage in response to the compensation voltage decreasing less than the slope voltage.

3. The circuit of claim 2, wherein the slope-compensation clamp circuit comprises:
a current source configured to provide the slope current;
a sampling resistor configured to generate the slope voltage from the slope current;
a sampling capacitor configured to sample the slope voltage; and
a regulation transistor device that is controlled by the slope-compensation error amplifier and is coupled between an input voltage and a compensation terminal on which the compensation voltage is provided.

4. The circuit of claim 3, wherein the slope-compensation clamp circuit further comprises a sampling switch that is closed in response to assertion of the switching signal to provide the slope voltage to the sampling capacitor.

5. The circuit of claim 4, wherein the switching signal is provided to the slope-compensation clamp circuit for sampling the slope voltage in a pulse frequency modulation (PFM) mode of the switching converter.

6. The circuit of claim 1, wherein the peak current mode controller further comprises a feedback error amplifier configured to generate the compensation voltage on a compensation terminal based on an amplitude of a feedback voltage associated with the output voltage of the switching converter relative to a predefined reference voltage, wherein the slope-compensation clamp circuit is coupled to the compensation terminal to set the minimum amplitude of the compensation voltage.

7. The circuit of claim 1, wherein the slope-compensation clamp circuit is configured to set the minimum amplitude of the compensation voltage greater than a peak minimum threshold amplitude of the compensation voltage below which the amplitude of the slope-compensation current is zero.

8. The circuit of claim 1, wherein the slope-compensation clamp circuit is configured to clamp the compensation voltage to the minimum amplitude during a pulse frequency modulation (PFM) mode of the switching converter.

9. The circuit of claim 1, wherein the peak current mode controller further comprises:
a slope generator configured to generate the slope current;
a summation component configured to generate the slope-compensation current based on subtracting the slope current from the compensation current associated with the compensation voltage; and
a comparator configured to compare the inductor current with the slope-compensation current to generate the activation signal.

10. The circuit of claim 9, wherein the slope generator comprises a current mirror configured to provide the slope current to the slope-compensation clamp circuit.

11. A circuit comprising:
a comparator configured to generate an activation signal in response to an inductor current of a switching converter being equal to a slope-compensation current, the slope-compensation current comprising a sum of a slope current and a compensation current generated via a compensation voltage;
a feedback error amplifier configured to generate the compensation voltage based on an amplitude of a feedback voltage associated with an output voltage of the switching converter relative to a predefined reference voltage;
a slope generator configured to generate the slope current; and
a slope-compensation clamp circuit configured to clamp the compensation voltage to a minimum amplitude based on the slope current.

12. The circuit of claim 11, wherein the slope-compensation clamp circuit is configured to generate a slope voltage associated with the slope current, wherein the slope-compensation clamp circuit comprises a slope-compensation error amplifier configured to regulate the compensation voltage to be approximately equal to the slope voltage in response to the compensation voltage decreasing less than the slope voltage.

13. The circuit of claim 12, wherein the slope-compensation clamp circuit comprises:
a current source configured to provide the slope current;
a sampling resistor configured to generate the slope voltage from the slope current;
a sampling capacitor configured to sample the slope voltage; and
a regulation transistor device that is controlled by the slope-compensation error amplifier and is coupled between an input voltage and a compensation terminal on which the compensation voltage is provided.

14. The circuit of claim 13, wherein the activation signal is provided to a switch controller that is configured to generate a switching signal in response to the activation signal, the switching signal being configured to activate at least one switch associated with the switching converter, wherein the slope-compensation clamp circuit further comprises a sampling switch that is closed in response to assertion of the switching signal to provide the slope voltage to the sampling capacitor.

15. The circuit of claim 14, wherein the switching signal is provided to the slope-compensation clamp circuit for sampling the slope voltage in a pulse frequency modulation (PFM) mode of the switching converter.

16. A circuit comprising:
a current source having an input and an output, the input of the current source being adapted to receive a slope current of a peak current mode controller of a switching converter system;
a resistor having a first terminal and a second terminal, the first terminal of the resistor being coupled to the output of the current source and the second terminal of the resistor being coupled to a low-voltage rail;
a switch comprising a control input, a switch input, and a switch output, the control input being adapted to receive a switching signal of the switching converter system, the switch input being coupled to the output of the current source;
a sampling capacitor having a first terminal and a second terminal, the first terminal of the sampling capacitor being coupled to the switch output and the second terminal of the sampling capacitor being coupled to the low-voltage rail;
a slope-compensation error amplifier having a first input, a second input, and an output, the first input of the slope-compensation error amplifier being coupled to the switch output, the second input of the slope-compensation error amplifier being coupled to a compensation terminal that is adapted to receive a compensation voltage for slope-compensation control of the switching converter system; and
a regulation transistor device having a first input, a second input, and an output, the first input of the regulation transistor device being coupled to the output of the slope-compensation error amplifier, the second input of the regulation transistor device being adapted to receive an input voltage, and the output of the regulation transistor device being coupled to the compensation terminal.

17. The circuit of claim 16, further comprising a feedback error amplifier having a first input, a second input, and an output, the first input of the feedback error amplifier being adapted to receive a predefined reference voltage, the second input of the feedback error amplifier being adapted to receive a feedback voltage associated with an output voltage, and the output of the feedback error amplifier being coupled to the compensation terminal.

18. The circuit of claim 16, further comprising a summation component having a first input, a second input, and an output, the first input of the summation component being coupled to the compensation terminal, the second input of the summation component being adapted to receive the slope current of the peak current mode controller.

19. The circuit of claim 18, further comprising a slope generator having a first output and a second output, the first output being coupled to the input of the current source, and the second output being coupled to the second input of the summation component.

20. The circuit of claim 19, further comprising a comparator having a first input, a second input, and an output, the first input of the comparator being adapted to receive an inductor current of the switching converter system, the second input of the comparator being coupled to the output of the summation component, and the output of the comparator being coupled to an input of a switch controller of the switching converter system.
